(19) United States
(12) Patent Application Publication
(10) Pub. No.: US 2024/0162822 A1
(43) Pub. Date: May 16, 2024

(54) SYSTEMS AND METHODS FOR OPERATION OF ASYMMETRIC HALF-BRIDGE FLYBACK POWER CONVERTERS

(71) Applicant: Navitas Semiconductor Limited, Dublin (IE)

(72) Inventors: Xiucheng Huang, Torrance, CA (US); Weijing Du, Torrance, CA (US); Yun Zhou, Shenzhen (CN)

(73) Assignee: Navitas Semiconductor Limited, Dublin (IE)

(21) Appl. No.: 18/500,009

(22) Filed: Nov. 1, 2023

(30) Foreign Application Priority Data
Nov. 10, 2022 (CN) 202211406902.6

(51) Int. Cl. H02M 3/335; H02M 1/00; H02M 3/00

(52) U.S. Cl. CPC H02M 3/33571; H02M 1/0058; H02M 3/01; H02M 3/33592

(57) ABSTRACT

Methods of operating a circuit are disclosed. In one aspect, disclosed methods includes providing a power converter circuit having transformer with a primary winding and secondary winding, a first switch and second switch coupled to the primary winding, a third switch coupled to the secondary winding, a controller coupled to the first and second switches. Disclosed methods further includes sensing a turn-on of the third switch and in response, transmitting a turn-on signal to the controller; and turning-on the second switch, using the controller, in response to receiving the turn-on signal. In another aspect, disclosed methods further includes sensing a turn-off of the third switch and in response, transmitting a turn-off signal to the controller using an isolation module, and turning-off the second switch, using the controller, in response to receiving the turn-off signal. In yet another aspect, the second switch is turned-off, using the controller, after a delay time.

### CROSS-REFERENCE TO RELATED APPLICATIONS

The present application claims priority to Chinese Patent Application No. 202211406902.6 (Attorney Docket No. 096868-1356915-007500CNP) filed on Nov. 10, 2022, entitled “CONTROL METHOD FOR ASYMMETRIC HALF-BRIDGE FLYBACK CONVERTER”, the contents of which are incorporated herein by reference in their entirety for all purposes.

### FIELD

The described embodiments relate generally to power converters, and more particularly, the present embodiments relate to systems and methods for control and operation of asymmetric half-bridge flyback power converters.

### BACKGROUND

Electronic devices such as computers, servers and televisions, among others, employ one or more electrical power conversion circuits to convert one form of electrical energy to another. Some electrical power conversion circuits use switching power supplies such as a flyback converter. Switching power supplies can efficiently convert power from a source to a load. Switching power supplies may have relatively high power conversion efficiency, as compared to other types of power converters. Switching power supplies may also be substantially smaller and lighter than a linear supply due to the smaller transformer size and weight.

### SUMMARY

In some embodiments, a method of controlling a circuit is disclosed. The method includes providing a power converter circuit having a transformer including a primary winding extending between a first terminal and a second terminal, and further including a secondary winding extending between a third terminal and a first output terminal; a first switch having a first gate terminal, a first source terminal and a first drain terminal, the first drain terminal coupled to the second terminal and the first source terminal coupled to a power source; a second switch having a second gate terminal, a second source terminal and a second drain terminal, the second source terminal coupled to the second terminal, and the second drain terminal coupled to the power source; a third switch having a third gate terminal, a third source terminal and a third drain terminal, the third source terminal coupled to the third terminal and the third drain terminal coupled to a second output terminal. The method further includes providing a controller coupled to the first and second gate terminals; sensing a turn-on of the third switch and in response, transmitting a turn-on signal to the controller; and turning-on the second switch, using the controller, in response to receiving the turn-on signal.

In some embodiments, the method further includes sensing a turn-off of the third switch and in response, transmitting a turn-off signal to the controller; and turning-off the second switch, using the controller, in response to receiving the turn-off signal.

In some embodiments, the turning-off the second switch occurs after a delay time T_{delay}.

In some embodiments, the time delay T_{delay} corresponds to a drain-source voltage V_{ds_on} of the first switch.

In some embodiments, the controller includes a turn-off management module where the turn-off management module stores N threshold voltages V_{TH_1}, V_{TH_2}, . . . , and V_{TH_N} having different magnitudes, wherein V_{TH_1}<V_{TH_2}< . . . <V_{TH_N}, and wherein the N threshold voltages correspond to N different delay times T_{delay_1}, T_{delay_2}, . . . , and T_{delay_N}, where T_{delay_1}<T_{delay_2}< . . . <T_{delay_N}.

In some embodiments, the turn-off management module detects the drain-source voltage V_{ds_on} of the first switch when the first switch was turned on in a previous cycle.

In some embodiments, the magnitudes of the drain-source voltage V_{ds_on} of the first switch and N different threshold voltages are compared in order to select the delay time T_{delay} from a look up table containing T_{delay_1}, T_{delay_2}, . . . , and T_{delay_N}.

In some embodiments, the second switch has a maximum on-time T_{on_max}, and wherein when the on-time of the second switch exceeds the maximum on-time T_{on_max}, the turn-off management module turns off the second switch immediately.

In some embodiments, a if within a particular time interval Tₛₚ, the turn-off management module does not receive the turn-off signal, the turn-off management module controls the second switch to temporarily enter a special control mode transiently, and wherein when the turn-off management module receives the turn-off signal again, the second switch will immediately exit the special control mode.

In some embodiments, when the second switch is in a special control mode, the turn-off management module determines a demagnetization time and controls the turn-off of the second switch corresponding to the demagnetization time.

In some embodiments, the transmitting the turn-on signal to the controller is performed using an isolation module.

In some embodiments, the isolation module includes an optocoupler isolation or a magnetic isolation and/or a capacitive isolation.

In some embodiments, the power converter circuit further includes a capacitor coupled between the second terminal and the second source terminal.

In some embodiments, a method of controlling a circuit disclosed. The method includes providing a power converter circuit having a transformer including a primary winding extending between a first terminal and a second terminal, and further including a secondary winding extending between a third terminal and a first output terminal; a first switch having a first gate terminal, a first source terminal and a first drain terminal, the first drain terminal coupled to the second terminal and the first source terminal coupled to a power source; a second switch having a second gate terminal, a second source terminal and a second drain terminal, the second source terminal coupled to the second terminal, and the second drain terminal coupled to the power source; a third switch having a third gate terminal, a third source terminal and a third drain terminal, the third source terminal coupled to the third terminal and the third drain terminal coupled to a second output terminal. The method further includes providing a controller coupled to the first and second gate terminals, and turning-on the second switch, using the controller, in response to sensing a turn-off of the first switch.

In some embodiments, a circuit is disclosed. The circuit includes a transformer having a primary winding extending between a first terminal and a second terminal, and further including a secondary winding extending between a third terminal and a first output terminal; a first switch having a first gate terminal, a first source terminal and a first drain terminal, the first drain terminal coupled to the second terminal and the first source terminal coupled to a power source; a second switch having a second gate terminal, a second source terminal and a second drain terminal, the second source terminal coupled to the second terminal, and the second drain terminal coupled to the power source; a third switch having a third gate terminal, a third source terminal and a third drain terminal, the third source terminal coupled to the third terminal and the third drain terminal coupled to a second output terminal; and a controller coupled to the first and second gate terminals, wherein the controller is arranged to receive a turn-on signal corresponding to a turn-on of the third switch, and wherein the controller is further arranged to turn-on the second switch in response to receiving the turn-on signal.

In some embodiments, the controller is further arranged to receive a turn-off signal corresponding to a turn-off of the third switch, and wherein the controller is arranged to turn-off the second switch in response to receiving the turn-off signal.

In some embodiments, the circuit further includes an isolation module that is arranged to transmit signals from a secondary side to a primary side of the transformer.

In some embodiments, the isolation module includes an optocoupler isolation or a magnetic isolation and/or a capacitive isolation.

In some embodiments, the circuit further includes a capacitor coupled between the second terminal and the second source terminal.

In some embodiments, the controller is further arranged to turn-off the second switch after a delay time T_{delay}.

### BRIEF DESCRIPTION OF THE DRAWINGS

FIG. 1 shows a schematic of an asymmetric half-bridge flyback converter with a controller according to certain embodiments;

FIG. 2 shows a method of operating the asymmetric half-bridge flyback converter using the controller of FIG. 1, according to some embodiments;

FIG. 3 shows a method of operating the asymmetric half-bridge flyback converter using the controller of FIG. 1, according to some embodiments;

FIG. 4 shows a method of operating an asymmetric half-bridge flyback converter using the controller of FIG. 1, according to certain embodiments;

FIG. 5 shows a method of operating an asymmetric half-bridge flyback converter using the controller of FIG. 1, according to some embodiments;

FIG. 6 shows a method of operating an asymmetric half-bridge flyback converter using the controller of FIG. 1, according to certain embodiments;

FIG. 7 illustrates a flowchart of a method 700 for control of an auxiliary switch in an asymmetric half-bridge flyback converter according to certain embodiments; and

FIGS. 8A-8D show simulation results of methods of operating an asymmetric half-bridge flyback converter according to some embodiments.

### DETAILED DESCRIPTION

Circuits, devices and related techniques disclosed herein relate generally to power converters. More specifically, circuits, devices and related techniques disclosed herein relate to control and operation methods for operation of asymmetric half-bridge flyback power converters where a turn-off signal of the main switch can be used to control turn-on of the auxiliary switch. In some embodiments, a secondary-side synchronous rectifier switch turn-on signal can be used to control turn-on of the auxiliary switch in the asymmetric half-bridge flyback power converter. Control and operation methods disclosed herein can enable improved performance of the asymmetric half-bridge flyback converter by enabling zero-voltage switching (ZVS) of the main switch and zero-current switching (ZCS) of the secondary-side synchronous rectifier switch under all operating conditions including light load conditions. In this way, the efficiency of the asymmetric half-bridge flyback converter can be improved, and the electromagnetic interference (EMI) performance of the power converter can be improved which can enable high frequency operations where gallium nitride (GaN) based switches are used.

In some embodiments, a turn-on signal for the synchronous rectifier switch may be used to generate a turn-on signal for the auxiliary switch. After generation of the turn-on signal for the synchronous rectifier switch, the turn-on signal for the synchronous rectifier switch can be transmitted to the primary side through an isolation module to generate the turn-on signal for the auxiliary switch. In various embodiments, the turn-off signal of the synchronous rectifier switch can be used to generate a first turn-off signal for turning off the auxiliary switch. After the generation of the turn-off signal of the synchronous rectifier switch, the turn-off signal can be transmitted to the primary side through an isolation module. In some embodiments, a primary side turn-off management module can receive the first turn-off signal and add a delay time before turning off the auxiliary switch. The delay time can be based on a drain-source voltage of the main switch, where timing of the turn-off of the auxiliary switch can be adjusted based on the drain-source voltage of the main switch that was sensed in a previous cycle. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

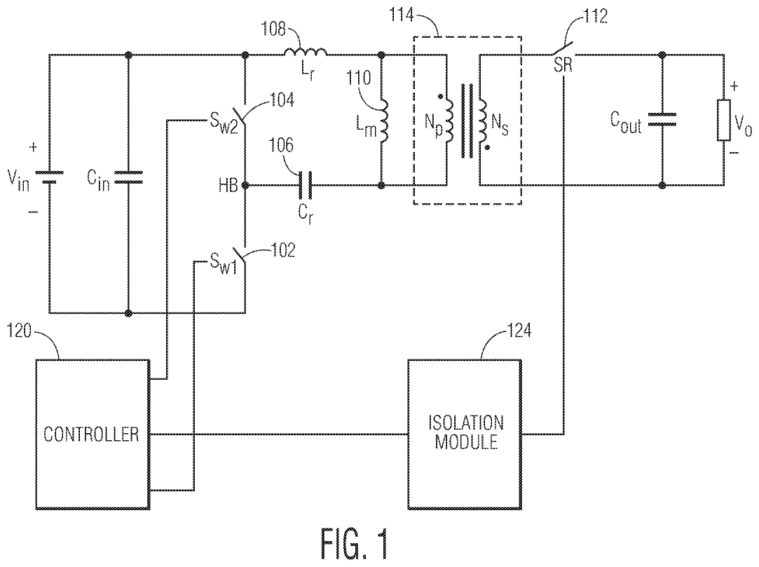

FIG. 1 shows a schematic of an asymmetric half-bridge flyback converter with a controller 100 according to certain embodiments. As shown in FIG. 1, the asymmetric half-bridge flyback converter with the controller 100 can include a main switch 102, an auxiliary switch 104, a synchronous rectifier switch 112, a resonant capacitor 106, an excitation inductance 110 and a leakage inductance 108 of a transformer 114. The main switch 102 and the auxiliary switch 104 are on the primary side, while the synchronous rectifier switch 112 is on the secondary side. When the main switch 102 is turned on, and the auxiliary switch 104 and the synchronous rectifier switch 112 are turned off, the excitation inductance 110 and the resonant capacitor 106 can store energy. When the main switch is turned off and the auxiliary switch is turned on, the energy stored in the transformer may be released to the secondary side.

When the main switch 102 is turned off, and the auxiliary switch 104 and the synchronous rectifier switch 112 are turned on, the excitation inductance 110 may be clamped by an output voltage, the leakage inductance 108 and the resonant capacitor 106 may resonate with a resonant period of Tr. In this way, the main switch 102 may operate with zero-voltage switching-on (ZVS), thus the asymmetric half-bridge flyback converter can reduce the switching loss of the main switch 102 and improve its EMI performance.

As shown in FIG. 1, a controller 120 is coupled to the main switch 102 and to the auxiliary switch 104. The controller may be arranged to transmit control signals to the main switch 102 and to the auxiliary switch 104 in order to control their turn on and turn off. In some embodiments, the controller 120 can include a pulse width modulation (PWM) controller circuit. In various embodiments, the controller 120 may include a turn-off management module circuit. In certain embodiments, the controller 120 may include driver circuits for the main switch 102 and the auxiliary switch 104. The In some embodiments, the main switch 102 and the auxiliary switch 104 can be silicon based MOS transistors. In various embodiments, the main switch 102 and the auxiliary switch 104 can be gallium nitride based (GaN) HEMTs. In some embodiments, the main switch 102 and the auxiliary switch 104 can be silicon carbide based MOS transistors. In various embodiments, the main switch 102 and the auxiliary switch 104 can be bipolar transistors. In some embodiments, the synchronous rectifier switch can be silicon-based MOS transistor, GaN-based transistor, silicon carbide-based transistor or bipolar transistor. The asymmetric half-bridge flyback converter with the controller 100 can further include an isolation module 124. In some embodiments, the isolation module can be an optocoupler isolation, a magnetic isolation and/or a capacitive isolation or the like. The isolation module 124 can be arranged to transmit signals from the secondary side to the primary side. In various embodiments, the isolation module may be arranged to transmit and receive signals from the secondary side to the primary side.

In current approaches, the asymmetric half-bridge flyback converter is controlled using a primary-side control mode. In these approaches, when the main switch 102 is turned off, the turn-on of the auxiliary switch 104 can be controlled by the turn-off signal of the main switch 102. The synchronous rectifier switch 112 may achieve zero-current switching-off (ZCS) only under certain working conditions, but not all working conditions. This can cause electromagnetic interference (EMI) performance degradation as well as a reduction of the efficiency of the asymmetric half-bridge flyback converter.

In some embodiments, an asymmetric half-bridge flyback converter with a turn-off management module can operate with higher efficiency and with reduced EMI. In various embodiments, efficient control of a turn-on and turn-off of the auxiliary switch 104 can achieve ZCS of the synchronous rectifier switch 112 under all operating conditions, thereby significantly improving the performance of the asymmetric half-bridge flyback converter. In some embodiments, when the main switch 102 is turned on and the auxiliary switch 104 is turned off, the transformer 114 and the resonant capacitor 106 can store energy. Upon turn-off of the main switch 102 and turn-on of the auxiliary switch 104, the energy stored in the transformer 114 and the resonant capacitor 106 is released to the secondary circuit.

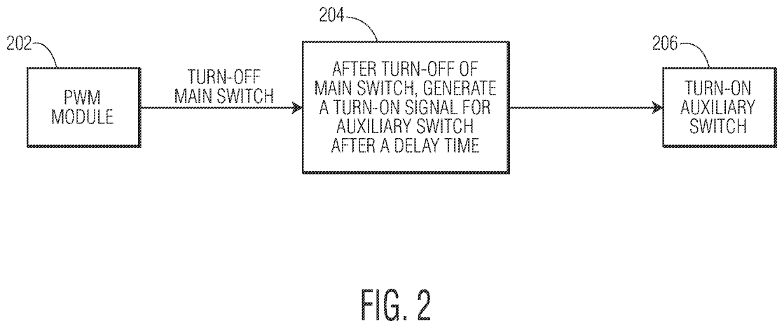

FIG. 2 shows a method of operating an asymmetric half-bridge flyback converter according to certain embodiments. In the illustrated method, the asymmetric half-bridge flyback converter can be operated to such that the auxiliary switch's turn-on and turn-off can be precisely controlled. In the illustrated embodiment, a turn-off signal turning off the main switch 102 can cause a turn-on of the auxiliary switch 104. A pulse width modulation (PWM) module 202 may send a turn-off signal to the main switch 102. Upon the turn-off of main switch 102, the auxiliary switch's turn-on signal can be generated after a delay time period(step 204). The auxiliary switch's turn-on signal can cause the auxiliary switch 104 to turn on (step 206).

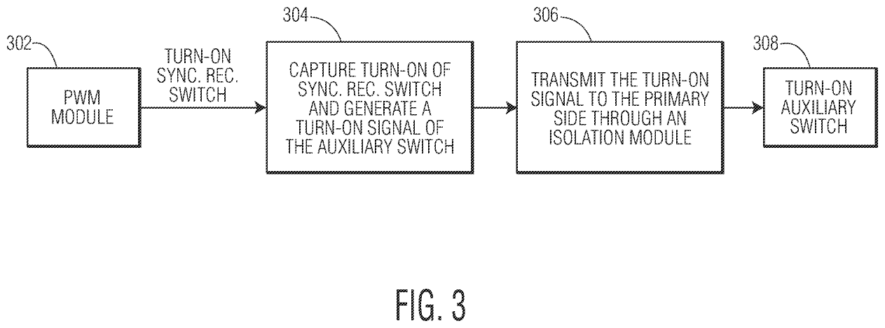

FIG. 3 shows a method of operating an asymmetric half-bridge flyback converter according to some embodiments. In the illustrated embodiment, a pulse width modulation (PWM) module 302 may send a turn-on signal to the synchronous rectifier switch 112. When the synchronous rectifier switch 112 is turned on, a signal that indicates that the synchronous rectifier switch has been turned on may be captured, and then a turn-on signal for the auxiliary switch 104 may be generated (step 304). The turn-on signal of the auxiliary switch can be transmitted to the primary side of the asymmetric half-bridge flyback converter through an isolation module (step 306). The isolation module may be an optocoupler isolation, magnetic isolation, capacitive isolation or the like. Subsequently, the auxiliary switch can be turned on (step 308).

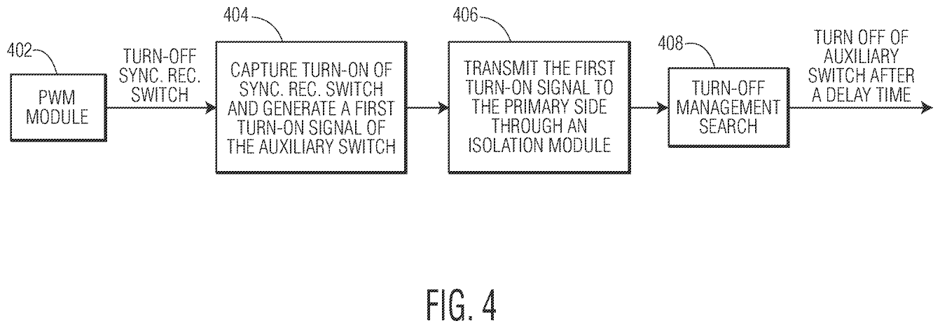

FIG. 4 shows a method of operating an asymmetric half-bridge flyback converter according to certain embodiments. In the illustrated embodiment, a pulse width modulation (PWM) module 402 may send a turn-off signal to the synchronous rectifier switch 112. The turn-off signal of the synchronous rectifier switch 112 can be used to generate a first turn-off signal of the auxiliary switch (step 404). The first turn-off signal of the auxiliary switch can be transmitted to a turn-off management module (408) on the primary side through an isolation module (step 406).

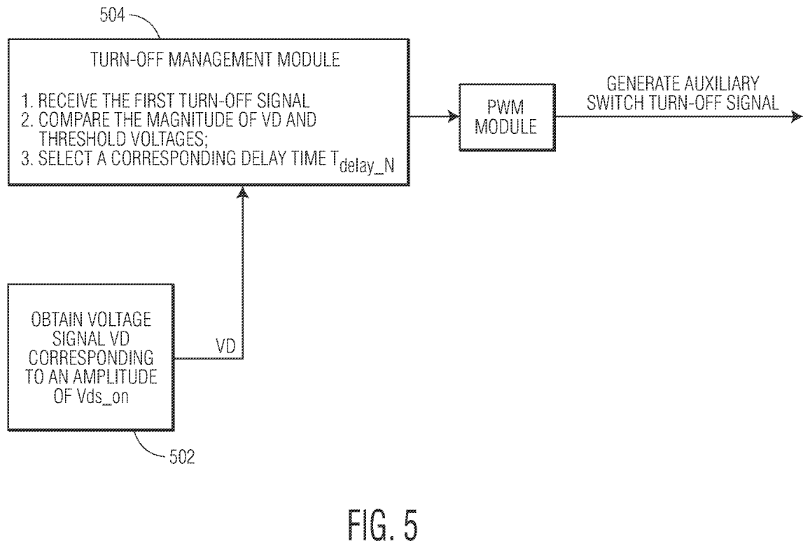

FIG. 5 shows a method of operating an asymmetric half-bridge flyback converter according to some embodiments. When turn-off management module 504 receives a first turn-off signal, the turn-off management module 504 may turn off the auxiliary switch after adding a delay time T_{delay}. T_{delay} corresponds to a drain-source voltage V_{ds_on} at the time the main switch 102 was turned on. The delay time T_{delay} may be used to adjust the turn-off time of the auxiliary switch 104, thus ensuring that the main switch 102 operates with zero-voltage turn-on or valley-voltage turn-on. The turn-off management module 504 can sense the drain-source voltage Vas on when the main switch 102 is turned on in order to obtain a voltage signal VD reflecting the amplitude of Vas on (step 502). The sensing of the drain-source voltage V_{ds_on} can be performed directly or through indirect methods. A value of voltage difference between VD and corresponding threshold voltages V_{TH} can be used by the turn-off management module in order to select a corresponding delay time T_{delay}.

In the illustrated embodiment, N threshold voltages V_{TH_1}, V_{TH_2}, . . . , and V_{TH_N} of different magnitudes can be stored in the turn-off management module 504 (e.g., in a look up table), where V_{TH_1}<V_{TH_2}< . . . <V_{TH_N}, and the N threshold voltages correspond to N different delay times T_{delay_1}, T_{delay_2}, . . . , and T_{delay_N}, where T_{delay_1}<T_{delay_2}< . . . <T_{delay_N}. In some embodiments, the turn-off management module 504 can be included in the controller 120. When receiving the first turn-off signal, the turn-off management module 504 can select a corresponding delay time T_{delay} according to the voltage signal VD (VD was sensed in a previous switching cycle). When VD≤V_{TH_1}, and after receiving the first turn-off signal, the turn-off management module 504 can turn off the auxiliary switch 104 after a delay time T_{delay_1}. When V_{TH_1}<VD≤V_{TH_2}, after receiving the first turn-off signal, the turn-off management module 504 can turn off the auxiliary switch 104 after a delay time T_{delay_2}. When V_{TH_N-1}<VD≤V_{TH_N}, after receiving the first turn-off signal, the turn-off management module 504 can turn off the auxiliary switch 104 after the delay time T_{delay_N-1}. When VD>V_{TH_N}, after receiving the first turn-off signal, the turn-off management module 504 can turn off the auxiliary switch 104 after a delay time T_{delay_N}. In the illustrated embodiment, the auxiliary switch 104 can have a maximum on-time of T_{on_max}. When the on-time tₒₙ of the auxiliary switch exceeds the maximum on-time T_{on_max}, i.e., tₒₙ>T_{on_max}, the turn-off management module 504 can override and turn off the auxiliary switch 104.

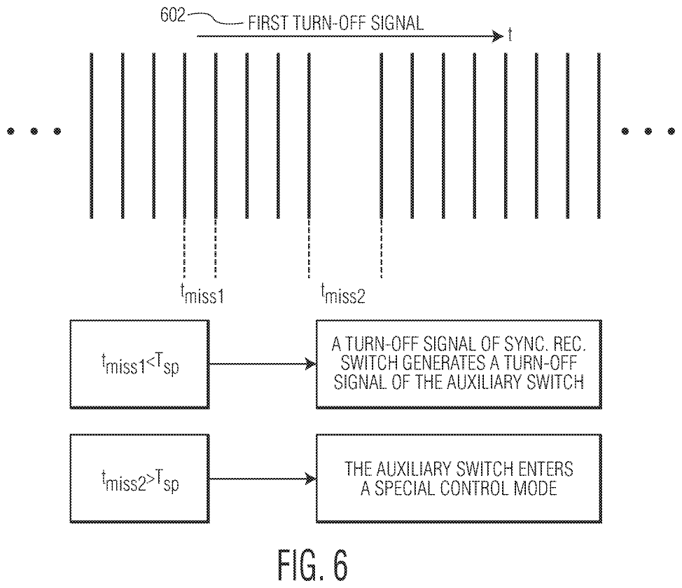

FIG. 6 shows a method of operating an asymmetric half-bridge flyback converter according to certain embodiments. Under operating conditions that the turn-off management module 504 does not receive the first turn-off signal, the turn-off management module can detect the time when the first turn-off signal 602 disappears. In FIG. 6, tₘᵢₛₛ is the disappearance time of the first turn-off signal. Under a condition when the first turn-off signal disappearance is less than Tₛₚ, i.e., tₘᵢₛₛ<Tₛₚ, the auxiliary switch 104 is declared to be in a normal working mode. Tₛₚ is a predefined time period. In some embodiments, Tₛₚ may have a value 1.2 to 1.5 times the demagnetization time t_{dmag}, however other values for Tₛₚ may be used.

The turn-off signal of the synchronous rectifier switch 112 may control the turn-off of the auxiliary switch to ensure that the synchronous rectifier switch 112 can operate under ZCS. During a time period when the first turn-off signal disappears, if that disappearance time exceeds Tₛₚ, i.e., tₘᵢₛₛ>Tₛₚ, the turn-off management module can cause the auxiliary switch 104 to enter a special control mode for a temporary time period. Moreover, when the turn-off management module 504 receives the first turn-off signal again, the auxiliary switch 104 can immediately exit the special control mode. When the auxiliary switch enters the special control mode, the turn-off management module 504 can calculate the demagnetization time t_{dmag} of the transformer 114, determine the turn-off time of the auxiliary switch, and cause the auxiliary switch to be turned off.

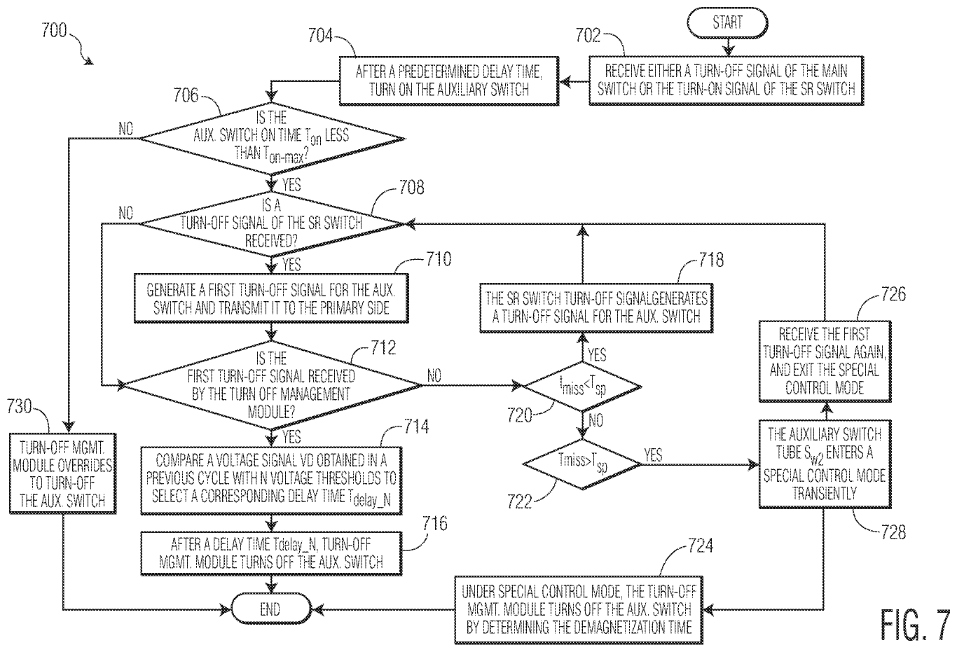

FIG. 7 illustrates a flowchart of a method 700 for control of an auxiliary switch in an asymmetric half-bridge flyback converter according to certain embodiments. In step 702, the method 700 includes receiving either a turn-off signal of the main switch 102 or the turn-on signal of the synchronous rectifier switch 112. In step 704, after a predetermined delay time, the auxiliary switch 104 can be turned on. In step 706, the method includes determining whether the auxiliary switch on time Tₒₙ is less than T_{on_max}. If Tₒₙ is less than T_{on_max}, in step 708 the method determines whether the turn-off signal of the synchronous rectifier switch is received. If yes, in step 710, a first turn-off signal for the auxiliary switch is generated and transmitted to the primary side through an isolation module. In step 712, the method determines whether the first turn-off signal is received by the turn-off management module. If yes, in step 714, a voltage signal VD is compared to N threshold voltages in a look-up table and a delay time T_{delay_N} is selected that corresponds to the corresponding threshold voltage in the look-up table. In step 716, after the time T_{delay_N} the turn-off management module turns off the auxiliary switch.

In step 706, if time Tₒₙ is not less than T_{on_max}, in step 730, the turn-off management module can override in order to turn-off the auxiliary switch. In step 712, if first turn-off signal in not received by the turn-off management module, then in step 720 tₘᵢₛₛ is compared to Tₛₚ to determine if tₘᵢₛₛ is less than Tₛₚ. If tₘᵢₛₛ is less than Tₛₚ, in step 718, the synchronous rectifier switch turn-off signal can generate a turn-off signal for the auxiliary switch. If during the time when the first turn-off signal disappears that time exceeds Tₛₚ, i.e., tₘᵢₛₛ>Tₛₚ, (step 722), the turn-off management module can cause the auxiliary switch 104 to enter a special control mode for a temporary time period (step 728). Moreover, when the turn-off management module 504 receives the first turn-off signal again, the auxiliary switch 104 can exit the special control mode (step 726). When the auxiliary switch enters the special control mode, the turn-off management module 504 can calculate the demagnetization time t_{dmag} of the transformer, determine the turn-off time of the auxiliary switch, and control the auxiliary switch to be turned off (step 724). It will be appreciated that method 700 is illustrative and that variations and modifications are possible. Steps described as sequential may be executed in parallel, order of steps may be varied, and steps may be modified, combined, added or omitted.

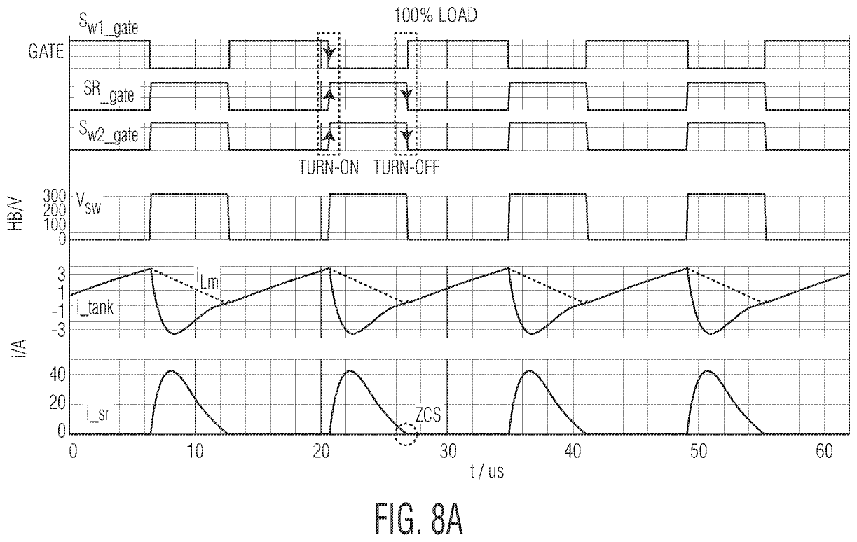

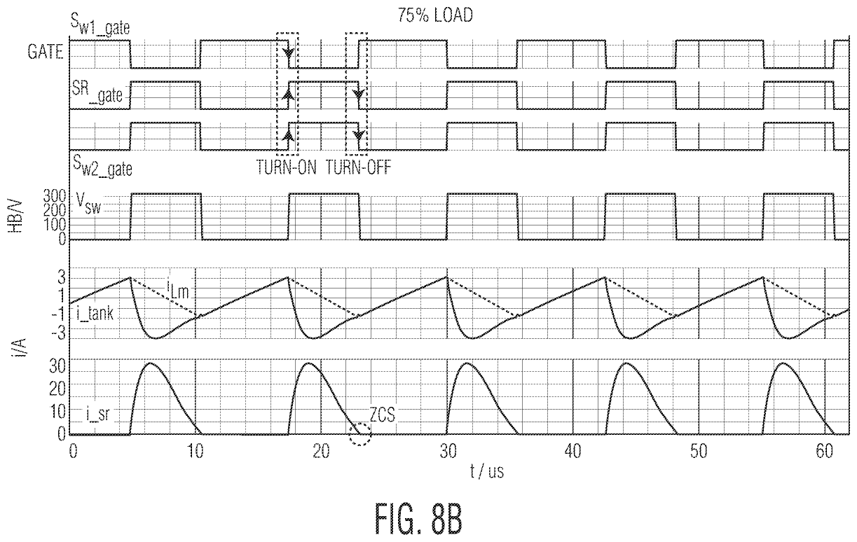

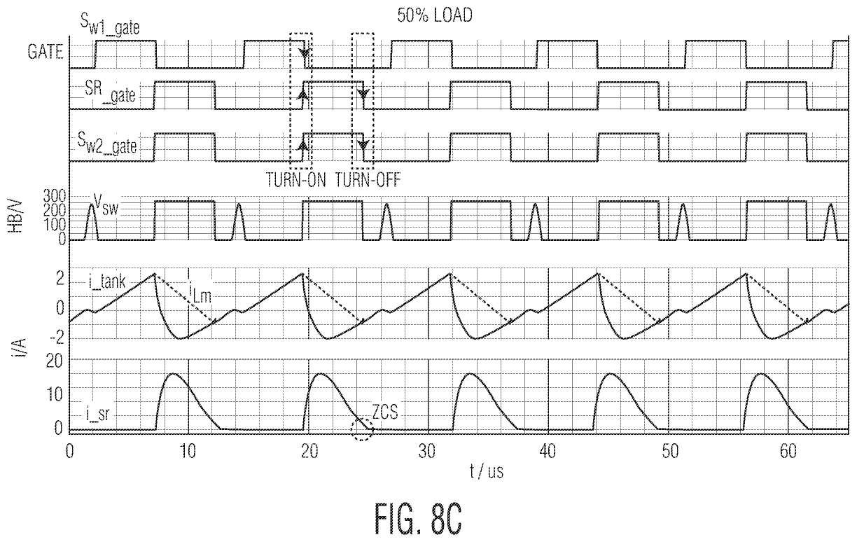

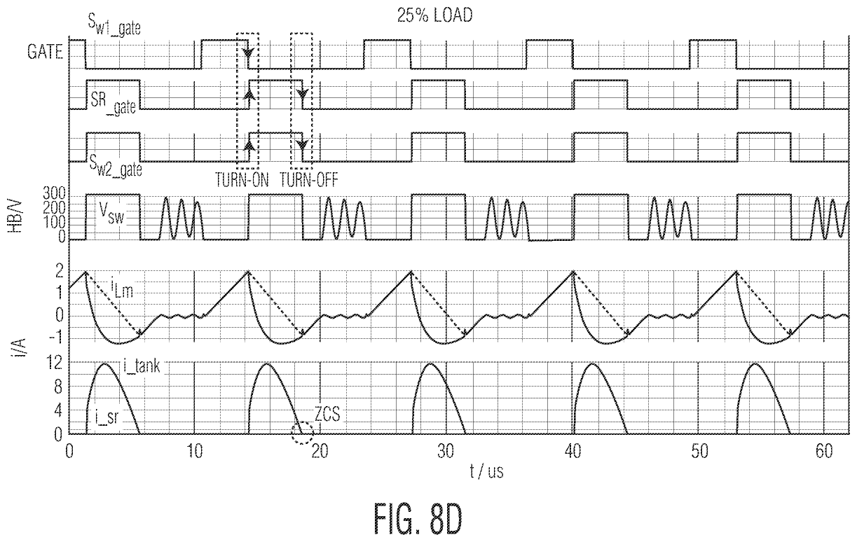

FIGS. 8A-8D show simulation results of methods of operating an asymmetric half-bridge flyback converter according to some embodiments. FIGS. 8A-8D show simulation waveforms for the asymmetric half-bridge flyback converter with different output loads. As can be seen in FIGS. 8A-8D, when the main switch 102 is turned off, embodiments of the disclosure can detect the occurrence of this event and can cause the auxiliary switch 104 to turn on. In some embodiments, when the synchronous rectifier switch 112 is turned on, the occurrence of this event is detected, and can cause the auxiliary switch 104 to turn on. When the synchronous rectifier switch 112 is turned off, the occurrence of this event is detected and a first turn-off signal of the auxiliary switch is generated, and the auxiliary switch 104 is turned off. Embodiments of the disclosure can ensure that the synchronous rectifier switch 112 can achieve zero-current switching-off (ZCS) at 100% load (FIG. 8A), 75% load (FIG. 8B), 50% load (FIG. 8C), and 25% load (FIG. 8D), which can improve the efficiency and EMI performance of the asymmetric half-bridge flyback converter.

In some embodiments, combination of the circuits and methods disclosed herein can be utilized to operate an asymmetric half-bridge flyback converter. Although circuits and methods are described and illustrated herein with respect to several particular configuration of methods of controlling and operating an asymmetric half-bridge flyback converter, embodiments of the disclosure are suitable for methods of controlling and operating other power converter topologies, such as, but not limited to, half-bridge flyback and LLC converters.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A method of controlling a circuit, the method comprising:
providing a power converter circuit comprising:
a transformer including a primary winding extending between a first terminal and a second terminal, and further including a secondary winding extending between a third terminal and a first output terminal;
a first switch having a first gate terminal, a first source terminal and a first drain terminal, the first drain terminal coupled to the second terminal and the first source terminal coupled to a power source;
a second switch having a second gate terminal, a second source terminal and a second drain terminal, the second source terminal coupled to the second terminal, and the second drain terminal coupled to the power source;
a third switch having a third gate terminal, a third source terminal and a third drain terminal, the third source terminal coupled to the third terminal and the third drain terminal coupled to a second output terminal;
providing a controller coupled to the first and second gate terminals;
sensing a turn-on of the third switch and in response, transmitting a turn-on signal to the controller; and
turning-on the second switch, using the controller, in response to receiving the turn-on signal.

2. The method of claim 1, further comprising:
sensing a turn-off of the third switch and in response, transmitting a turn-off signal to the controller; and
turning-off the second switch, using the controller, in response to receiving the turn-off signal.

3. The method of claim 2, wherein the turning-off the second switch occurs after a delay time T_{delay}.

4. The method of claim 3, wherein the time delay T_{delay} corresponds to a drain-source voltage V_{ds_on} of the first switch.

5. The method of claim 4, wherein the controller comprises a turn-off management module and wherein the turn-off management module stores N threshold voltages V_{TH_1}, V_{TH_2}, . . . , and V_{TH_N} having different magnitudes, wherein V_{TH_1}<V_{TH_2}< . . . <V_{TH_N}, and wherein the N threshold voltages correspond to N different delay times T_{delay_1}, T_{delay_2}, . . . , and T_{delay_N}, where T_{delay_1}<T_{delay_2}< . . . <T_{delay_N}.

6. The method of claim 5, wherein the turn-off management module detects the drain-source voltage V_{ds_on} of the first switch when the first switch was turned on in a previous cycle.

7. The method of claim 6, wherein magnitudes of the drain-source voltage V_{ds_on} of the first switch and N different threshold voltages are compared in order to select the delay time T_{delay} from a look up table containing T_{delay_1}, T_{delay_2}, . . . , and T_{delay_N}.

8. The method of claim 7, wherein the second switch has a maximum on-time T_{on_max}, and wherein when the on-time of the second switch exceeds the maximum on-time T_{on_max}, the turn-off management module turns off the second switch immediately.

9. The method of claim 8, wherein if within a particular time interval Tₛₚ, the turn-off management module does not receive the turn-off signal, the turn-off management module controls the second switch to temporarily enter a special control mode transiently, and wherein when the turn-off management module receives the turn-off signal again, the second switch will immediately exit the special control mode.

10. The method of claim 9, wherein when the second switch is in a special control mode, the turn-off management module determines a demagnetization time and controls the turn-off of the second switch corresponding to the demagnetization time.

11. The method of claim 1, wherein the transmitting the turn-on signal to the controller is performed using an isolation module.

12. The method of claim 11, wherein the isolation module comprises an optocoupler isolation or a magnetic isolation and/or a capacitive isolation.

13. The method of claim 1, wherein the power converter circuit further comprises a capacitor coupled between the second terminal and the second source terminal.

14. A method of controlling a circuit, the method comprising:
providing a power converter circuit comprising:
a transformer including a primary winding extending between a first terminal and a second terminal, and further including a secondary winding extending between a third terminal and a first output terminal;
a first switch having a first gate terminal, a first source terminal and a first drain terminal, the first drain terminal coupled to the second terminal and the first source terminal coupled to a power source;
a second switch having a second gate terminal, a second source terminal and a second drain terminal, the second source terminal coupled to the second terminal, and the second drain terminal coupled to the power source;
a third switch having a third gate terminal, a third source terminal and a third drain terminal, the third source terminal coupled to the third terminal and the third drain terminal coupled to a second output terminal;
providing a controller coupled to the first and second gate terminals; and
turning-on the second switch, using the controller, in response to sensing a turn-off of the first switch.

15. A circuit comprising:
a transformer including a primary winding extending between a first terminal and a second terminal, and further including a secondary winding extending between a third terminal and a first output terminal;
a first switch having a first gate terminal, a first source terminal and a first drain terminal, the first drain terminal coupled to the second terminal and the first source terminal coupled to a power source;
a second switch having a second gate terminal, a second source terminal and a second drain terminal, the second source terminal coupled to the second terminal, and the second drain terminal coupled to the power source;
a third switch having a third gate terminal, a third source terminal and a third drain terminal, the third source terminal coupled to the third terminal and the third drain terminal coupled to a second output terminal; and
a controller coupled to the first and second gate terminals;
wherein the controller is arranged to receive a turn-on signal corresponding to a turn-on of the third switch, and wherein the controller is further arranged to turn-on the second switch in response to receiving the turn-on signal.

16. The circuit of claim 15, wherein the controller is further arranged to receive a turn-off signal corresponding to a turn-off of the third switch, and wherein the controller is arranged to turn-off the second switch in response to receiving the turn-off signal.

17. The circuit of claim 15, further comprising an isolation module that is arranged to transmit signals from a secondary side to a primary side of the transformer.

18. The circuit of claim 17, wherein the isolation module comprises an optocoupler isolation or a magnetic isolation and/or a capacitive isolation.

19. The circuit of claim 15, further comprising a capacitor coupled between the second terminal and the second source terminal.

20. The circuit of claim 16, wherein the controller is further arranged to turn-off the second switch after a delay time T_{delay}.
